(19) United States
(12) Patent Application Publication
(10) Pub. No.: US 2026/0038707 A1
(43) Pub. Date: Feb. 5, 2026

(54) METHOD FOR OPERATING A QUANTUM DEVICE

(71) Applicant: Oxford Ionics Limited, Begbroke (GB)

(72) Inventors: Maciej MALINOWSKI, Obergengstringen (CH); David Thomas Charles ALLCOCK, Eugene, OR (US)

(21) Appl. No.: 18/676,940

(22) Filed: May 29, 2024

(51) Int. Cl. G21K 1/00

(52) U.S. Cl. CPC G21K 1/20

(57) ABSTRACT

A method for operating a quantum device, wherein the quantum device comprises a plurality of magnetic field generators, and an array of trapped ions, the method comprising applying the generated magnetic fields to the array of trapped ions; and performing control operations using the quantum device by applying an electric field to each trapped ion of the array, wherein the electric field is generated by applying a voltage to a plurality of input ports of the quantum device.

The present disclosure relates to individual tuning of trapped ions within an array in a quantum device.

### BACKGROUND

In a quantum device comprising a plurality of trapped ions, problems arise when attempting to control N trapped ions using a magnetic field. It is known to do this by using N magnetic fields, wherein each magnetic field is separately modulated and aimed at a single ion or small group of ions.

There is a need for a better solution for controlling, using magnetic fields, a plurality of trapped ions.

### BRIEF SUMMARY

In a first aspect of the disclosure, there is provided a method for operating a quantum device, wherein the quantum device comprises a plurality of magnetic field generators, and an array of trapped ions, the method comprising: applying the generated magnetic field to the array of trapped ions; and performing control operations using the quantum device by applying an electric field to each trapped ion of the array, wherein the electric field is generated by applying a voltage to a plurality of input ports of the quantum device.

Optionally, wherein the performing control operations comprises applying each electric field to a group of at least one trapped ion of the trapped ion array.

Optionally, wherein the array is configured such that the trapped ions are positioned in a plurality of groups, wherein each group comprises at least one trapped ion.

Optionally, wherein the plurality of magnetic field generators are wiredly connected; and wherein each magnetic field generator is associated with one group of the plurality of groups of trapped ions such that the generated magnetic field is applied to the associated group of trapped ions for each magnetic field generator.

Optionally, wherein the magnetic field generators are wired in series.

Optionally, wherein the magnetic field generators are wired in parallel.

Optionally, wherein the magnetic field generators are wired in a combination of series and parallel.

Optionally, wherein the control operations are coherent operations.

Optionally, wherein the control operations are performed by applying the electric field to individual ions of the plurality of trapped ions to control translational and/or oscillation modes of the ions.

Optionally, wherein the control operations include at least one of: operation Rabi frequency tuning; transition frequency tuning; operation phase tuning; and entangling gate Rabi frequency tuning.

Optionally, wherein the entangling gate Rabi frequency tuning is performed by one of: ion translation, mode frequency tuning, or mode orientation tuning.

Optionally, wherein the coherent operations include quantum operations; and wherein the quantum operations include at least one of a single-qubit gate and a multi-qubit gate.

In a second aspect of the disclosure, there is provided a quantum device comprising: a plurality of magnetic field generators, each configured to generate a magnetic field; an array of trapped ions; wherein the quantum device is configured to: apply the generated magnetic field to the array of trapped ions; and perform control operations using the quantum device by applying an electric field to each trapped ion individually, wherein the electric field is generated by applying a voltage to a plurality of input ports of the quantum device.

Optionally, configured to receive at least one laser beam from at least one laser light input; wherein the at least one laser beam is applied to the array of trapped ions.

Optionally, wherein the quantum device is configured to receive at least one laser beam from two or more laser light inputs.

Optionally, further comprising at least one laser light input.

Optionally, comprising two or more laser light inputs.

### BRIEF DESCRIPTION OF THE DRAWINGS

The disclosure is described in further detail below by way of example only and with reference to the accompanying drawings in which:

FIG. 1 is a flowchart illustrating a method for operating a quantum device;

FIG. 2 is a diagram representing an magnetic field generator arrangement for operating a quantum device according to a first embodiment;

FIG. 3 is a diagram representing an magnetic field generator arrangement for operating a quantum device according to a second embodiment;

FIGS. 4a, 4b, and 4c are diagrams of various magnetic field generator wiring arrangements according to the first embodiment;

FIGS. 5a and 5b are diagrams of performing a control operation by controlling an translational movement of a trapped ion of the trapped ion;

FIGS. 6a and 6b are diagrams of performing a control operation by controlling an oscillation movement of a trapped ion of the trapped ion; and

FIGS. 7a and 7b are diagrams of performing a control operation by controlling a squeezing or widening potential of a trapped ion of the trapped ion; and

FIG. 8 is a block diagram representing a quantum device.

### DETAILED DESCRIPTION

The following text will refer to a “quantum device” which refers to a quantum device which utilises quantum physics in order to perform computations or simulations, or to store data. For example, the quantum device may utilise quantum-mechanical systems including two-state systems (qubits), three-state systems (qutrits), four-state systems, and quantum mechanical continuous variable systems. In some examples, the quantum mechanical systems may be controlled using “all-electronic control” wherein the quantum mechanical systems are controlled using electric and/or magnetic fields. In other examples, the quantum mechanical systems may be controlled using laser fields. The quantum mechanical systems are controlled to perform quantum operations including coherent quantum operations (or “quantum gates”) and dissipative quantum operations such as qubit reset and qubit measurement.

In the following text, the quantum mechanical systems are encoded into electronic energy levels of ions, wherein the ions are stored in an ion trap. The ion trap comprises electrodes to which voltages may be applied to generate electromagnetic fields which may be used for the purpose of ion storage and manipulation. For example, the ion trap may be an RF trap (or “Paul trap”) or Penning trap or the like. For example, the ion trap may be a chip trap (or “surface-electrode trap”) or a stacked wafer trap (or “3D trap”).

Trapped ion systems for quantum computing purposes (for example, the ion-trap chips of the disclosure), in general, comprise an ion trap in a vacuum chamber, at least one voltage source coupled to the ion trap and configured to apply a voltage to an electrode of the ion-trap chip to generate an electric field, a source of neutral atoms, a source of static magnetic field, a plurality of lasers and a fluorescence detector. The plurality of lasers serve a number of purposes, including the excitation and photo-ionisation of the neutral atoms into ions and laser cooling of ions.

In the following text, “control operations” refer to any operations which can be carried out inside the ion trap. For example, the control operations include coherent operations (such as quantum gates).

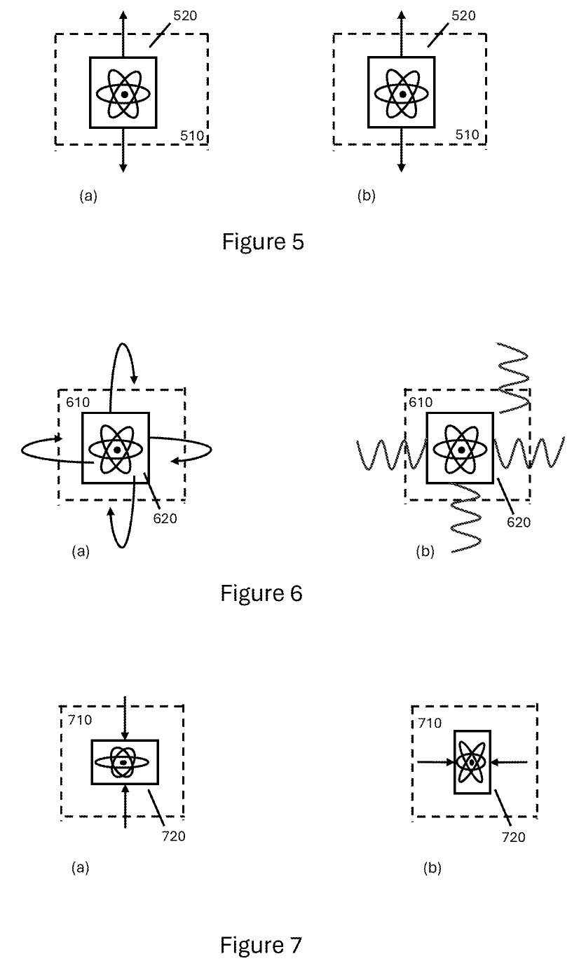

The control operations are operations carried out using the ion-trap chips by applying a voltage to an electrode of the ion-trap chips in order to generate an electromagnetic field wherein the electric part of the electromagnetic field is used to control translational and/or oscillation modes of the ions. The voltage is applied in combination with the applications of a laser and/or magnetic field pulse. These modes are described in detail with reference to FIGS. 5, 6, and 7.

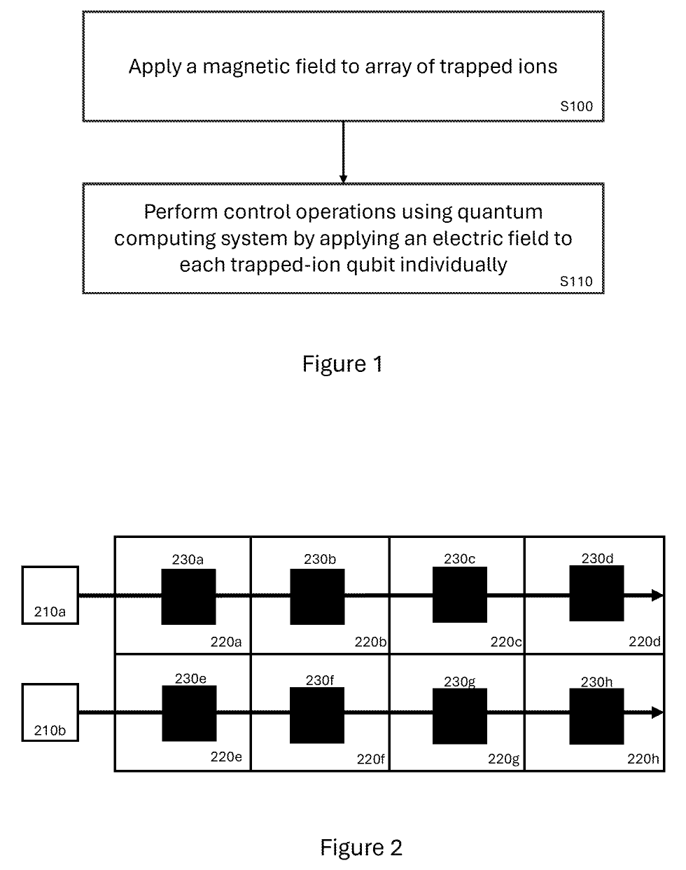

FIG. 1 is a flowchart illustrating a method for operating a quantum device, wherein the quantum device comprises a plurality of magnetic field generators configured to generate a magnetic field and an array of trapped ions comprising a plurality of trapped ions.

The magnetic field generators may be any structure which can be used to generate a magnetic field. For example, the magnetic field generators may be antennas, such as near-field antennas.

In step S100, the generated magnetic field is applied to the array of trapped ions.

The array of trapped ions may be configured such that the trapped ions are positioned in a plurality of groups (or zones), wherein each group comprises a plurality of trapped ion. For example, the trapped ions may be positioned such that they are grouped within specific zones such that a small number of trapped ions (for example, two or three) make up each group. Preferably, all groups have the same potential. In a typical example, there may be a few hundred individual groups in the quantum device.

The plurality of magnetic field generators may be connected together via wires, wherein each magnetic field generator may be associated with a group of the plurality of groups of trapped ions such that the generated magnetic field of each magnetic field generator is applied to the associated group of trapped ions for each magnetic field generator. For example, the plurality of magnetic field generators may be positioned such that each magnetic field generator of the plurality of magnetic field generators is in the vicinity of (for example, positioned above or below) a group of trapped ions. For example, the magnetic field generator may be near-field antennas and, as such, the generated magnetic fields may be focussed on specific areas, allowing the magnetic fields to be applied individually to each group of trapped ions.

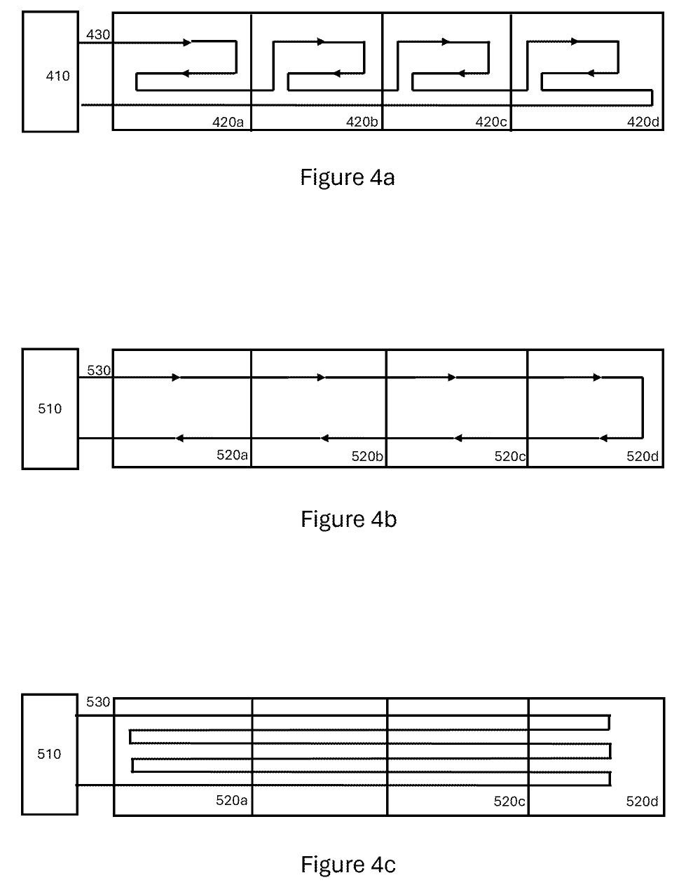

The magnetic field may be applied to the array by wiring the magnetic field generators in any of a plurality of wiring arrangements, including: in series; in parallel; or a combination thereof. These methods are described in more detail in FIGS. 4 and 5.

In step S110, control operations are performed using the quantum device by applying an electric field to each trapped ion individually, wherein the electric field is generated by applying a voltage to a plurality of input ports of the quantum device. For example, each trapped ion may be connected to an input port, via which a voltage is applied to the ion.

For example, there may be a plurality of electrodes positioned near each ion of the plurality of trapped ions such that, when a voltage is applied to the input ports, each input port generates an electric field at and around the position of the ions. These generated electric fields allow the ion to be moved in various ways (for example, by translation, oscillation, and/or squeezing), thus allowing control operations to be performed.

That is, one or more control operations may be performed. The control operations are performed by applying a voltage to an input port to generate an electric field such that the electric field can be used to perform translation and/or oscillation tuning operations. The translation and/or oscillation tuning operations are described in more detail in FIGS. 6 to 8.

The control operations are performed by applying the voltage to the input ports while the magnetic field is being applied. Thus, control (or tuning) of each individual trapped ion is provided by modulating the electric field applied to each ion of the array of trapped ions. Thus, control operations can be performed using the array of trapped ions such that the same control operations may be carried out on multiple trapped ions at once; or different control operations may be carried out on multiple trapped ions at once. Additionally, it allows some trapped ions to not be used (i.e. “ion hiding”), as well as implementing different operations in different areas of the array at the same time.

In an example, the control operations are performed by applying the electric field while the magnetic field is being applied. In another example, the control operations are performed before the magnetic field is applied and, once the control operations have been performed, a magnetic field pulse is applied wherein the magnetic field is turned on and then turned off after a predefined period of time.

This approach allows magnetic fields to be applied to specific areas of the array of trapped ions, providing finer control in the tuning and operation of the quantum device.

The quantum device may comprise: a plurality of magnetic field generators, an array of trapped ions; wherein the quantum device is configured to: apply the generated magnetic field to the array of trapped ions; and perform control operations using the quantum device by applying an electric field to each trapped ion individually, wherein the electric field is generated by applying a voltage to a plurality of input ports of the quantum device.

The quantum device may be configured to receive at least one laser beam from at least one laser light input; wherein the at least one laser beam is applied to the array of trapped ions. That is, the laser beam may be applied to the array of trapped ions such that some or all of the trapped ions are caused to experience a laser field. For example, the quantum device may be configured to receive at least one laser beam from two or more laser light inputs.

The quantum device may further comprise at least one laser light input. For example, the quantum device may comprise two or more laser light inputs. That is, the at least one laser light input may be internal or external to the quantum device. In some examples, the at least one laser light input may be external to the quantum device, and the quantum device may receive the laser beams. In other examples, the at least one laser light input may be included in (or be part of) the quantum device.

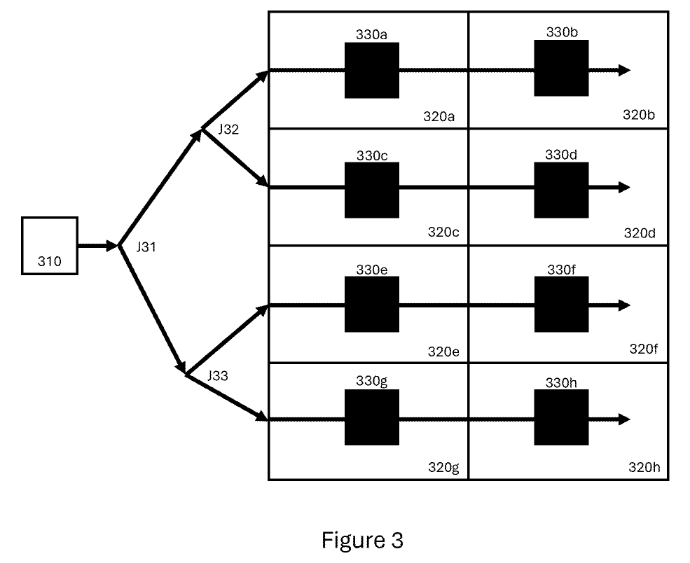

FIGS. 2 and 3 discuss magnetic field generator arrangements that can be used to perform the method described with reference to FIG. 1.

FIG. 2 is a diagram of a magnetic field generator arrangement for operating a quantum device according to a first embodiment.

A plurality of magnetic field generators 230a to 230h are positioned in zones 220a to 220h, wherein each of zones 220a to 220h include a group of trapped ions. The plurality of magnetic field generators 230a to 230h are wired in series such that each magnetic field generator of the plurality is positioned in the same vicinity as a zone 220a to 220h (and the group of trapped ions included in the zone). For example, each row of zones (for example, zones 220a to 220d and zones 220e to 220h) may be associated with a plurality of magnetic field generators, wherein each plurality of magnetic field generators is connected to a source 210a, 210b. For example, the source 210a, 210b may be a DC current source, an AC current source, or an arbitrary waveform generator. Additionally, the source may optionally be connected to an amplifier and/or to an impedance matching structure such as a transformer.

Examples of magnetic field generator structures that the plurality of magnetic field generators 230a to 230h may have may be found in patent application GB 2213239.3. A skilled person would understand that any magnetic field generator structure suitable for near-field application of magnetic fields could be used.

It should be understood that different series wiring can be used, as will be discussed further with reference to FIGS. 4a and 4b.

FIG. 3 is a diagram of a magnetic field generator arrangement for operating a quantum device according to a second embodiment.

A plurality of magnetic field generators 330a to 330h are positioned in zones 320a to 320h, wherein each of zones 320a to 320h include a group of trapped ions. The plurality of magnetic field generators 330a, 330c, 330e, and 330g are wired in parallel. The source 310 for the magnetic field generators is connected such that it passes through splitter J31 to create two paths and then each of those paths passes through splitters J32 and J33, respectively, to create four paths which each connect a magnetic field generator of the plurality of magnetic field generators 330a, 330c, 330e, and 330g to the source 310. As such, the plurality of magnetic field generators 330a, 330c, 330e, and 330g are connected in parallel.

In some examples, as illustrated, each of the magnetic field generators 330a, 330c, 330e, and 330g may then be wired in series to a further plurality of magnetic field generators. For example, magnetic field generator 330a is wired in series with magnetic field generator 330b, and so on.

In some examples, multiple sources may be provided.

FIGS. 4a, 4b, and 4c are diagrams of various magnetic field generator wiring arrangements according to the second embodiment. Each diagram represents a different way to connect a plurality of magnetic field generators in series, wherein arrows indicate a direction of current flow (it should be understood that current flow may be reversed in practice). The magnetic field generators may be configured to receive direct current (DC) or alternating current (AC). In the case that AC is used, the current may be low frequency. Each magnetic field generator may be configured to generate a magnetic field in its vicinity (for example, an area surrounding the magnetic field generator, wherein the size of the area may be predetermined or controlled) due to the passing of current through conductive elements of the magnetic field generator.

For example, the plurality of magnetic field generators may be wired such that each magnetic field generator of the plurality is positioned in the vicinity of a group of trapped ions, such that each magnetic field generator may provide a magnetic field to one or more groups of trapped ions. The magnetic field generators may be near-field magnetic field generators, which allows a magnetic field to be provided to a specific area by each magnetic field generator. Thus, each group of the one or more groups of trapped ions can be provided with a magnetic field by a specific one or more magnetic field generators.

For example, FIG. 4a shows a wiring arrangement in which both a series of magnetic field generator are wired together. That is, each group of trapped ions is served by an magnetic field generator (that is, each magnetic field generator provides a magnetic field to one group of trapped ions), wherein the plurality of magnetic field generators are wired together in series.

In contrast, FIG. 4b shows a wiring arrangement in which the magnetic field generators are wired such that a top row of magnetic field generators are wired together first, before wiring the bottom row.

FIG. 4c shows an arrangement wherein the plurality of magnetic field generators is a single magnetic field generator that is wired such that it provides a magnetic field to a plurality of groups of ions at the same time.

In some examples, these wiring arrangements may be used in combination with a parallel wiring arrangement. For example, as shown in FIG. 3, a first group of magnetic field generators may be wired in parallel and then each of this first group of magnetic field generators may then be wired to a further plurality of magnetic field generators in series.

FIGS. 5 to 7 are diagrams which represent performing a control operation by controlling a translational or oscillation mode of a trapped ion of the array. The trapped ion is a charged particle which, when within a magnetic field, can be caused to move in various ways according to the application of an electric field. As such, the trapped ions of the array can be individually tuned by moving them within the applied magnetic field by applying the electric field.

FIGS. 5a and 5b are diagrams which represent performing a control operation by controlling translational movement of a trapped ion of the trapped ions of the array.

A magnetic field 510 is applied to the ion 520 according to any of the methods described with reference to FIGS. 2 to 4.

With reference to FIG. 5a, while the magnetic field 510 is being applied, an electric field is applied to the ion 520 (for example, generated via a voltage source such as an electrode coupled to the trapped ion) which causes the ion 520 to move in a translational mode, up or down (along a y axis) from a central position. The ion 520 is moved up or down within the magnetic field 510.

With reference to FIG. 5b, while magnetic field 510 is being applied, an electric field is applied to the ion 520 which causes the ion 520 to move in a translational mode, left or right (along an x axis) from a central position. The ion 520 is moved right or left within the magnetic field 510.

These translational modes can be used to modify at least one of a magnitude, a phase, and an orientation of a magnetic field experienced by the ion of the trapped ion. The translational modes can be used to modify the frequencies of internal and motional transitions of the trapped ions. At least one of these effects may be used to tune parameters of a Hamiltonian governing a time-evolution of the ion (for example, during coherent or dissipative operations). Thus, the translational modes may be used to perform operations such as operation Rabi frequency tuning, transition frequency tuning, operation phase tuning, and entangling gate Rabi frequency.

By applying a voltage to each trapped-ion of the array individually, it is possible to individually tune each trapped ion. As such, different operations can be performed on different trapped ions at the same time.

FIGS. 6a and 6b are diagrams of performing a control operation by controlling an oscillation movement of the trapped ion of the trapped ion.

A magnetic field 610 is applied to the ion 620 according to any of the methods described with reference to FIGS. 2 to 4.

With reference to FIG. 6a, while the magnetic field 610 is being applied, an electric field is applied to the ion 620 (for example, generated via a voltage source such as an electrode coupled to the trapped ion) which causes the ion 620 to spin (or turn) laterally or longitudinally about an axis (for example, an x, y, or z axis).

With reference to FIG. 6b, while the magnetic field 610 is being applied, an electric field is applied to the ion 620 which causes the ion 620 to oscillate up and down along an axis (for example, an x or y axis).

Referring to both FIG. 6a and 6b, the voltage can be applied to control two degrees of freedom of the ion within the magnetic field 610.

FIG. 7a and 7b are diagrams of performing a control operation by controlling a squeezing or widening potential of the trapped ion of the array.

A magnetic field 710 is applied to the ion 720 according to any of the methods described with reference to FIGS. 2 to 4.

With reference to FIG. 7a, while the magnetic field 710 is being applied, an electric field is applied to the ion 720 (for example, generated via a voltage source such as an electrode coupled to the trapped ion) which causes the ion 720 to be squeezed or widened laterally or longitudinally along an axis (for example, an x or y axis).

Additionally, an orientation of a potential of the ion may be changed, For example, by squeezing the ion potential along a direction x, the oscillation frequency of the ion may be increased along the direction x. For example, by widening the ion potential along the direction x, the oscillation frequency of the ion may be decreased along the direction x. For example, the ion potential can be rotated by x degrees in order to rotate the direction of the ion oscillation by x degrees.

To compare the translational and oscillation modes, it should be understood that ion translation along the direction x refers to moving a minimum of the ion potential along the direction x, while ion oscillation along the direction x refers to increasing an amplitude of the ion oscillation along the direction x.

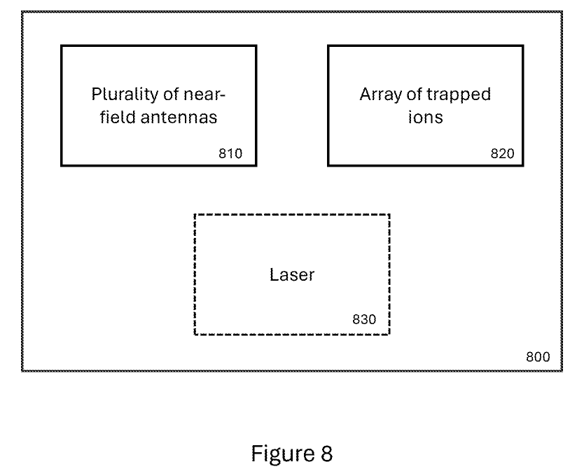

FIG. 8 is a block diagram representing a quantum device 800 such as the quantum device described with reference to FIG. 1.

The quantum device 800 comprises a plurality of magnetic field generators 810; an array of trapped ions 820; wherein the quantum device 800 is configured to receive at least one laser beam from at least one laser source; and wherein the quantum device 800 is configured to carry out the method described by reference to FIG. 1.

The quantum device may further comprise at least one laser light source 830, wherein the at least one laser light source is configured to apply at least one laser beam to the array of trapped ions. The at least one laser light source 830 may be used for a variety of operations, such as laser cooling and readout. The at least one laser 830 may be turned on at the same time as the plurality of magnetic field generators 810, or may be applied as a laser pulse. Alternatively, in some examples, the laser 830 may not be used at all.

The plurality of magnetic field generators 810 may be wired in series (for example, as shown in FIG. 2), parallel (for example, as shown in FIG. 3), or a combination of series and parallel (for example, as shown in FIG. 3). The plurality of magnetic field generators may 810 connected via wires.

The array of trapped ions 820 may be configured such that the trapped ions may be positioned (or organised) in a plurality of groups, wherein each group comprises a plurality of trapped ions.

Each magnetic field generator of plurality of magnetic field generators may 810 be associated with one group of the plurality of groups of trapped ions such that the generated magnetic field is applied to the associated group of trapped ions for each magnetic field generator.

It should be understood that the diagrams in FIGS. 2 to 7 are merely illustrative and should not be understood as limiting. It should be understood that these drawings are not geometrically accurate. For example, where a specific wiring pattern is shown, it should be understood that this is not intended to limit to the specific dimensions and proportions shown. Similarly, all angles are merely illustrative and should not be construed as limiting.

Various improvements and modifications may be made to the above without departing from the scope of the disclosure.

1. A method for operating a quantum device, wherein the quantum device comprises a plurality of magnetic field generators, and an array of trapped ions, the method comprising:
applying the generated magnetic fields to the array of trapped ions; and
performing control operations using the quantum device by applying an electric field to each trapped ion of the array, wherein the electric field is generated by applying a voltage to a plurality of input ports of the quantum device.

2. The method of claim 1, wherein the performing control operations comprises applying each electric field to a group of at least one trapped ion of the trapped ion array.

3. The method of claim 1, wherein the array is configured such that the trapped ions are positioned in a plurality of groups, wherein each group comprises at least one trapped ion.

4. The method of claim 3, wherein the plurality of magnetic field generators are connected via wires; and
wherein each magnetic field generator is associated with one group of the plurality of groups of trapped ions such that the generated magnetic field is applied to the associated group of trapped ions for each magnetic field generator.

5. The method of claim 4, wherein the magnetic field generators are wired in series.

6. The method of claim 4, wherein the magnetic field generators are wired in parallel.

7. The method of claim 4, wherein the magnetic field generators are wired in a combination of series and parallel.

8. The method of claim 5, wherein the magnetic field generators are wired in a combination of series and parallel.

9. The method of claim 6, wherein the magnetic field generators are wired in a combination of series and parallel.

10. The method of claim 1, wherein the control operations are coherent operations.

11. The method of claim 10, wherein the control operations are performed by applying the electric field to individual ions of the plurality of trapped ions to control translational and/or oscillation modes of the ions.

12. The method of claim 11, wherein the control operations include at least one of: operation Rabi frequency tuning; transition frequency tuning; operation phase tuning; and entangling gate Rabi frequency tuning.

13. The method of claim 12, wherein the entangling gate Rabi frequency tuning is performed by one of: ion translation, mode frequency tuning, or mode orientation tuning.

14. The method of claim 10, wherein the coherent operations include quantum operations; and
wherein the quantum operations include at least one of a single-qubit gate and a multi-qubit gate.

15. A quantum device comprising:
a plurality of magnetic field generators;
an array of trapped ions; and
wherein the quantum device is configured to:
apply the generated magnetic field to the array of trapped ions; and
perform control operations using the quantum device by applying an electric field to each trapped ion individually, wherein the electric field is generated by applying a voltage to a plurality of input ports of the quantum device.

16. The quantum device of claim 15, further configured to receive at least one laser beam from at least one laser light input;
wherein the at least one laser beam is applied to the array of trapped ions.

17. The quantum device of claim 16, wherein the quantum device is configured to receive at least one laser beam from two or more laser light input.

18. The quantum device of claim 16, further comprising at least one laser light input.

19. The quantum device of claim 18, comprising two or more laser light inputs.
